(19) United States
(12) Patent Application Publication
(10) Pub. No.: US 2009/0327003 A1
(43) Pub. Date: Dec. 31, 2009

(54) Electronic business method for monitoring the activity of an establishment

(76) Inventor: Andrew Paul Yamaoka, Zeeland, MI (US)

Correspondence Address: King & Partners, PLC, 170 College Avenue, SUITE 230, HOLLAND, MI, 49423, US

(21) Appl. No.: 12/215,711

(22) Filed: Jun. 27, 2008

(51) Int. Cl. G06F 19/00

(52) U.S. Cl. 705/7

(57) ABSTRACT

An electronic business method for monitoring the activity of an establishment, including the non-limiting step of: providing an electronic information database preferably associated with a server, wherein the electronic information database includes at least one establishment record; storing activity information about an establishment within an establishment record; receiving a search inquiry regarding the activity of an establishment; and generating at least one content page via a server, wherein the at least one content page includes activity information about an establishment.

### CROSS-REFERENCE TO RELATED APPLICATION(S)

Not Applicable

### BACKGROUND OF THE INVENTION

1. Field of the Invention

The present invention relates in general to an electronic business method and, more particularly, to an electronic business method for monitoring the activity of establishments, such as restaurants, bars, taverns, cafes, bistros, parlors, delis, diners, nightclubs, etcetera.

2. Background Art

Methods for monitoring the activity of an establishment have been known in the art for years. While conventional methods for monitoring activity have been known in the art for years, issues relative to the communication of activity information remain largely problematic. In particular, conventional methods include physically traveling to an establishment to assess the activity level thereof and/or telephonically contacting the establishment.

To be sure, traveling to an establishment without knowing its activity level not only serves to waste valuable resources such as gasoline, but if more than one establishment is visited, a considerable amount of time may be unnecessarily consumed. Telephonic monitoring is not without drawbacks as well. If the establishment is only open for a portion of the day, or is extremely busy, there is little likelihood of contacting the establishment.

It is therefore an object of the present invention to provide an electronic business method for monitoring the activity of an establishment, which, among other things, remedies the aforementioned detriments and/or complications.

These and other objects of the present invention will become apparent in light of the present specification, claims, and drawings.

### SUMMARY OF THE INVENTION

In one embodiment, the present invention is directed to an electronic business method for monitoring the activity of an establishment, comprising the steps of: (a) providing an electronic information database associated with a server, wherein the electronic information database comprises at least one establishment record; (b) storing activity information about an establishment within an establishment record; (c) receiving a search inquiry regarding the activity of an establishment; and (d) generating at least one content page via a server, wherein the at least one content page comprises activity information about an establishment that is stored within an establishment record that substantially corresponds to a search inquiry.

In a preferred embodiment of the present invention, the electronic business method further comprises the step of exporting, over a computer network, views of the at least one content page.

In another preferred embodiment of the present invention the electronic business method further comprises the step of authorizing a user by: (a) requesting a user identification from a user; (b) determining whether the user identification is valid; (c) granting access to modify an establishment record if the user identification is valid; and/or (d) denying access to modify an establishment record if the user identification is invalid.

In yet another preferred embodiment of the present invention the electronic business method further comprises the step of receiving activity information about the activity of an establishment, wherein the step of receiving activity information about the activity of an establishment is performed over an interface protocol.

In another aspect of the present invention the interface protocol comprises a World Wide Web application running hypertext transfer protocol.

In one preferred embodiment of the present invention the step of authorizing a user comes before the steps of storing activity information about an establishment within an establishment record and receiving activity information about the activity of an establishment.

In a preferred embodiment of the present invention the electronic business method further comprises the step of storing a patron record in an electronic information database.

In another preferred embodiment of the present invention the patron record further comprises a patron preference, wherein the patron preference comprises at least one of: a favorite establishment list, an activity upper limit, an activity lower limit, a proximity limit, and a price limit.

In yet another preferred embodiment of the present invention the electronic business method further comprises the step of storing reservation information within a patron record.

In another aspect of the present invention the reservation information comprises at least one of: a party name, a reservation time, a reservation quantity, and a seating preference.

In yet another preferred embodiment of the present invention the electronic business method further comprises the step of receiving a request for a reservation update.

In another aspect of the present invention the electronic business method further comprises the step of notifying a patron of a reservation update, wherein the reservation update comprises reservation information contained within a patron record.

In a preferred embodiment of the present invention the electronic business method further comprises the step of providing an alternative establishment record based upon at least one of a search inquiry and a patron preference.

In another preferred embodiment of the present invention the electronic business method further comprises the step of notifying a user of the activity of an establishment by transmitting activity information via a cellular telephone network.

In yet another preferred embodiment of the present invention the electronic business method further comprises the step of notifying a user of the activity of an establishment by transmitting activity information via an Internet protocol to an associated computer.

In another aspect of the present invention the activity information comprises an interactive monitoring device.

In one preferred embodiment of the present invention the activity information comprises at least one of: an establishment's current occupancy number, an establishment's previous occupancy number, a current reservation list, and a current call ahead list.

In a preferred embodiment of the present invention the establishment record comprises an establishment identification, wherein the establishment identification comprises at least one of: a unique identification data, an address, and an establishment name.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted. It will be understood that the invention is not necessarily limited to the particular embodiments illustrated herein.

The invention will now be described with reference to the drawings wherein:

FIG. 1A of the drawings is a schematic representation of an apparatus for use in conjunction with an electronic business method for monitoring the activity of an establishment, in accordance with the present invention;

FIG. 1B of the drawings is a schematic representation of a server for use in conjunction with an electronic business method for monitoring the activity of an establishment, in accordance with the present invention;

FIG. 2 of the drawings is a flowchart of an overview of an electronic business method for monitoring the activity of an establishment, in accordance with the present invention;

FIG. 3 of the drawings is a flowchart of a process controlling establishment access, in accordance with the present invention;

FIG. 4 of the drawings is a flowchart of a process controlling patron access to the system, in accordance with the present invention;

FIG. 5 of the drawings is a flowchart of a process controlling search inquiries of an electronic information database, in accordance with the present invention;

FIG. 6 of the drawings is a flowchart of a process controlling reservations, in accordance with the present invention;

FIG. 7 of the drawings is a flowchart of a process controlling reservation updates, in accordance with the present invention; and

FIG. 8 of the drawings is a view of a generated content page containing activity information, in accordance with the present invention.

### DETAILED DESCRIPTION OF THE INVENTION

While this invention is susceptible of embodiment in many different forms, there is shown in the drawings and flowcharts and described herein in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings with like reference characters.

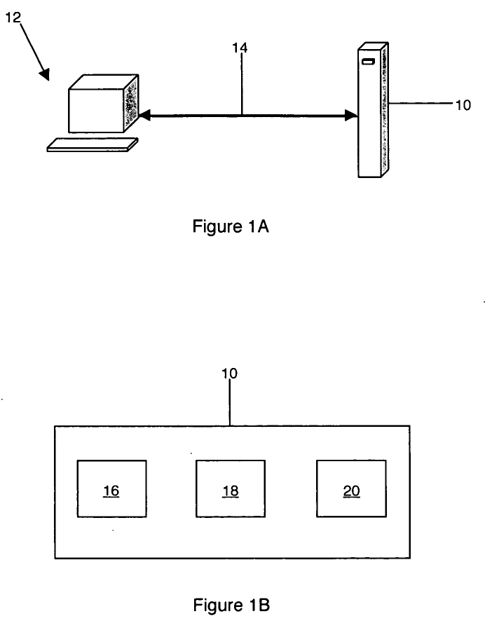

Referring now to the drawings, and to FIG. 1A in particular, a schematic representation of an apparatus for use in conjunction with an electronic business method for monitoring the activity of an establishment is shown. In accordance with the present invention, the system is implemented by programming server 10. The programming of server 10 may preferably comprise, for example, a coding language such as Pearl, although any one of a number of coding languages (e.g. java, C++, etc.) that would be known to one of ordinary skill in the art with the present disclosure before them are likewise contemplated for use in accordance with the present invention. In one embodiment, server 10 is preferably in communication with a number of client machines 12 via Internet 14.

Referring now to FIG. 1B, a schematic representation of a server for use in conjunction with an electronic business method for monitoring the activity of an establishment is shown. Server 10 is shown as preferably comprising processor 16, random access memory 18, and data storage 20. Data storage 20 may comprise, for example, an array of conventional disk drives that store a number of programs and data files including, but not limited to: establishment records, user records, activity information, and/or user preferences.

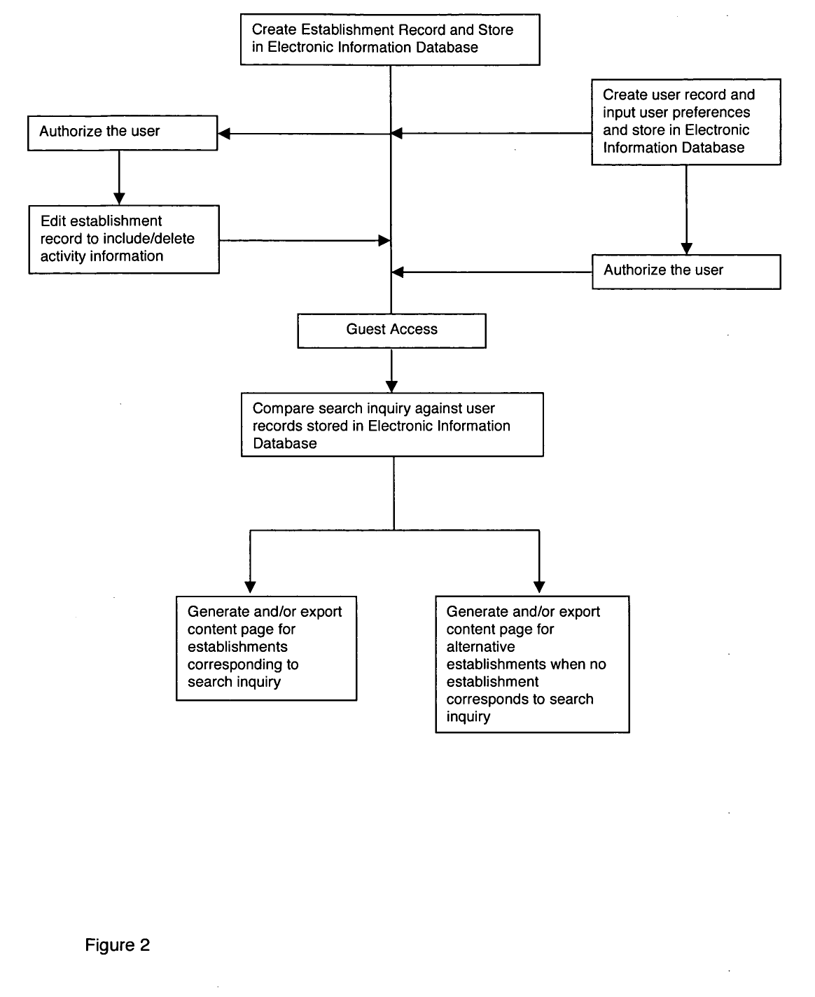

Referring now to FIG. 2, a flowchart of an overview of an electronic business method for monitoring the activity of an establishment is shown. The first step in the method preferably comprises the creation of an establishment record. Next, a user preferably gains access to the system via either a guest access, or by creating a patron record. Once a user gains access to the system, the user then inputs a search inquiry. After a user inputs a search inquiry, the system then preferably compares the search inquiry against establishment records. Lastly, the system preferably generates content pages based upon information contained within establishment records that at least substantially correspond to a search inquiry.

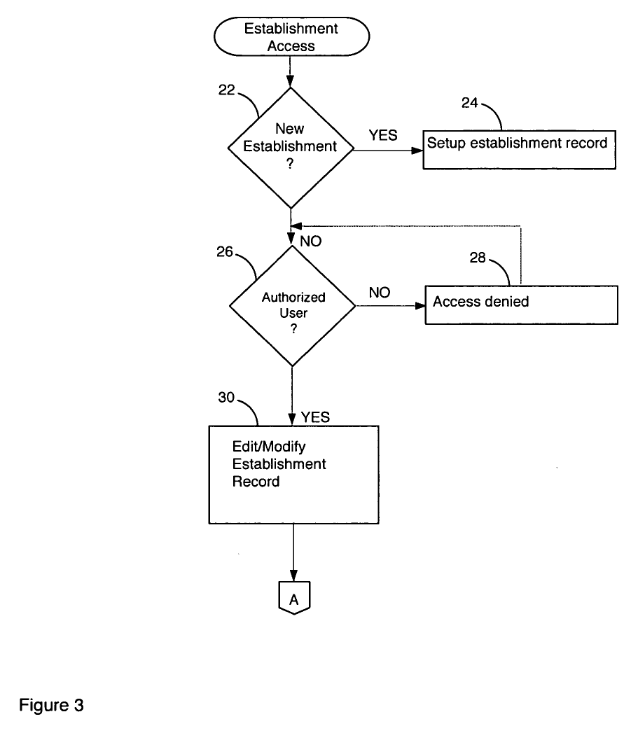

Referring now to FIG. 3, a flowchart of an establishment access process is shown. This process preferably begins at step 22 determining whether the establishment is a new establishment or an establishment with an existing record. If the establishment is new and an establishment record needs to be created, execution preferably branches to step 24. In order to create an establishment record, a user preferably navigates to a Web page generated and/or exported to client machines by the system. The user is then prompted to create an establishment record. The user creates an establishment record by inputting information into a plurality of input members. Input members may include, for example, text input boxes, list boxes, and/or drop-down boxes—just to name a few. It will be understood that information may preferably be received by the system via any number of commonly used interface protocols. In one embodiment, the interface protocol comprises a World Wide Web application running hypertext transfer protocol.

In accordance with the present invention, the information that is input by a user may preferably comprise, for example, establishment identification, and/or activity information. This information is then preferably stored in an establishment record. Establishment records are then stored in an electronic information database that resides within the data storage portion of a server.

Establishment identification may comprise, for example, a unique identification data, an address, and an establishment name. Establishment identification preferably aids a user in distinguishing one establishment from another.

After the user has input establishment identification, the user is prompted to input activity information. Activity information may preferably include, for example, an establishment's current occupancy number, a current reservation list, and/or a current call ahead list. Activity information may also preferably comprise occupancy numbers from previous dates and times. This type of activity information allows a user to forecast the most appropriate time for he/she to visit the establishment.

Activity information aids the user in choosing what establishment best suits their preference without wasting valuable resources and time traveling from establishment to establishment.

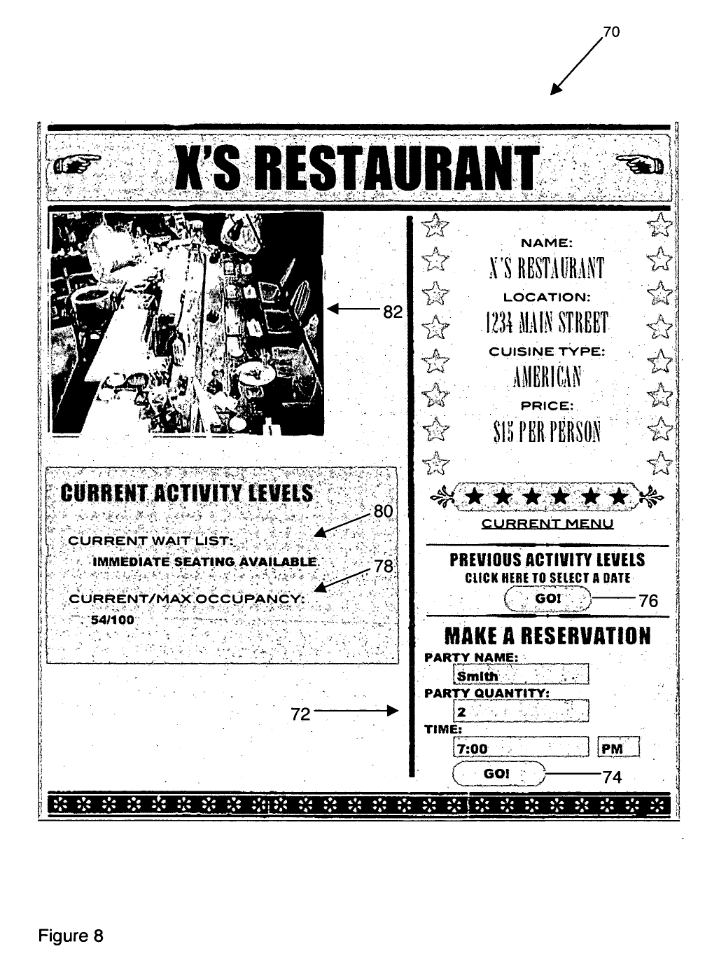

In accordance with the present invention, activity information may preferably further comprise an interactive monitoring device. In one embodiment, the interactive monitoring device may preferably comprise a webcam. This webcam preferably broadcasts a live video feed of an establishment via the Internet. It will be understood that this live video feed is displayed on a content page (see FIG. 8). Webcams allow an individual to view the current activity level of the establishment at a remote location without having to be physically present. Suitable locations for the placement of the webcam may include, for example, the entrance of an establishment or the bar area of an establishment.

In order to protect the integrity information within an establishment record, an establishment record may further comprise a user identification. The use of a user identification aids to ensure that only authorized users may access and edit the establishment record. It will be understood that a user identification may preferably be stored in a corresponding establishment record. Examples of user identification may include, a username and/or password.

If a user has previously created an establishment record containing a user identification, execution branches to step 26. Step 26 preferably authorizes the user and grants and/or denies access to an establishment record. It will be understood that step 26 preferably occurs before step 30, which allows a user to edit information contained within an existing establishment record.

During step 26, the system preferably prompts a user to input a user identification. Once the user identification has been input, the system compares it against the user identification stored in the establishment record.

If the user identification is invalid, execution branches to step 28 where access to the establishment record is denied. Optionally, the user may have another opportunity to input correct user identification. If the user identification is valid, execution preferably branches to step 30. Step 30 allows a user to edit, modify, delete or otherwise change an existing establishment record.

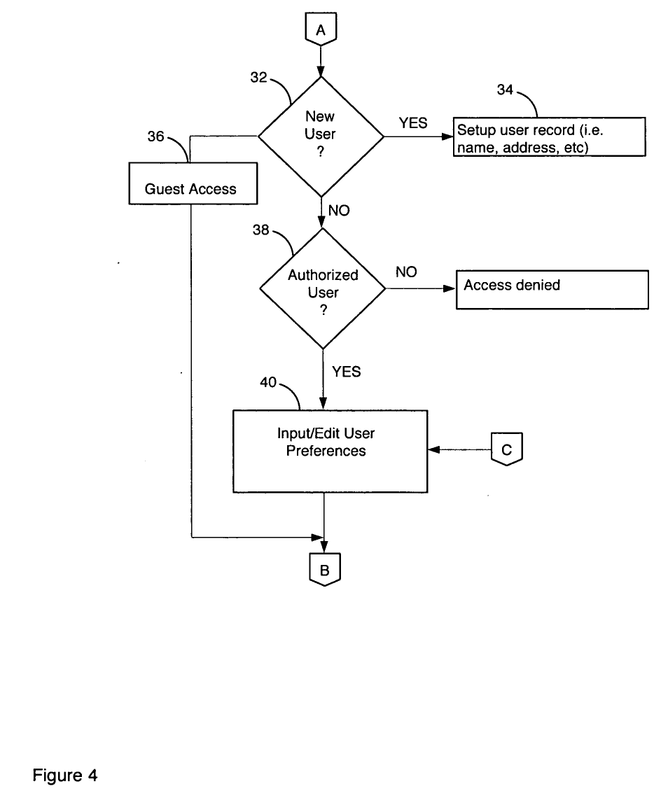

Referring now to FIG. 4, a flowchart of a process controlling patron access to the system is shown. First, step 32 preferably determines whether a user is a new or an existing patron. If the user is new, execution preferably branches to step 34. Step 34 allows a user to setup a patron record, input patron preferences, and/or store patron identification. As with an establishment record, a patron record is stored in an electronic information database that resides within the data storage portion of a server.

Patron preferences allow a patron to store historical information, for example, the establishments they frequent, in order to automate certain processes within the system. Other types of patron preferences may include activity upper limits that preferably allow the system to locate a quiet dining location. For example, a user may wish to locate restaurants with activity levels limited to fifty percent of maximum occupancy. An activity lower limit works similarly, though inversely to the activity upper limit, such as when a user wishes to find a busy bar or nightclub. Lastly, it will be understood that a user does not have to create a patron record to utilize the electronic business method though they may only be provided with guest access.

If a user is not new, and they do not wish to create a patron record, execution preferably branches to step 36 and the user is provided with guest access. It will be understood that a user with guest access may not have access to the aforementioned automated processes.

If the user is not new but they have previously created a patron record, execution branches to step 38. Step 38 preferably allows a patron to access not only the system, but also their patron record where they may edit, modify, delete or otherwise change information within their patron record. To access a patron record, the user is prompted to input patron identification. The patron identification is preferably compared with the patron identification stored in the patron record. If the patron identification is valid, execution branches to step 40. Step 40 preferably allows a user to edit, modify, delete or otherwise change an existing patron record.

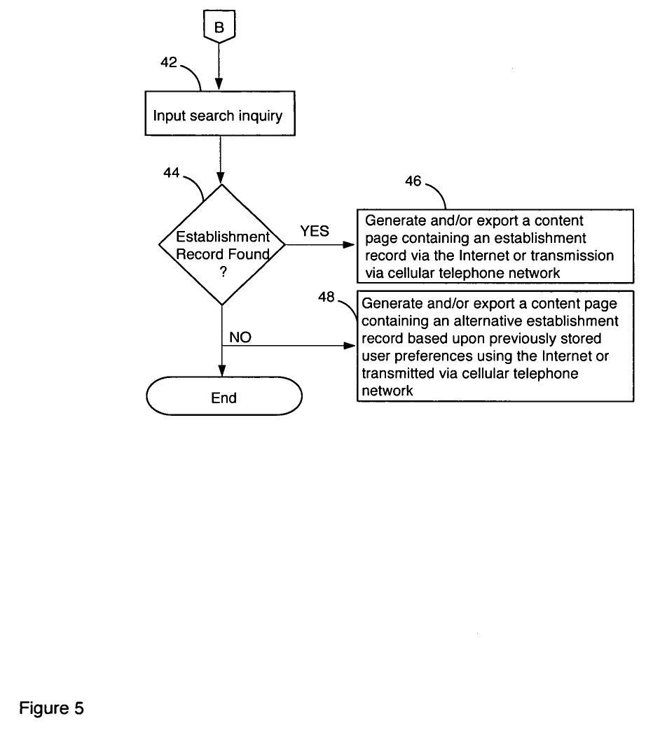

Referring now to FIG. 5, a flowchart of a process controlling search inquiries of an electronic information database is shown. First, step 42 preferably allows a user with guest access and/or a patron to input a search inquiry. In one embodiment of the present invention, a user accesses a search Web page generated and/or exported to client machines by the system. This search Web page comprises at least one of a variety of search input members that receive search inquiries, for example, text input, list boxes, drop down menus—just to name a few. In one embodiment, a user is prompted to input the name of a restaurant into a text box. Also, the user is prompted to enter their zip code and select a search radius (e.g. 5 miles, 15 miles, 20 miles) in that to search. Once a search inquiry has been inputted, execution branches to step 44. Step 44 preferably compares a search inquiry to establishment records stored within the electronic information database. If the search inquiry input in step 42 substantially corresponds to an existing establishment record, execution preferably branches to step 46. During execution of step 46, the system preferably generates and/or exports content pages (see FIG. 8) containing establishment records found during the search.

If the search inquiry input in step 42 does not substantially correspond to an existing establishment record, execution branches to step 48. It will be understood that step 48 occurs only if the user is a patron with an existing patron record. The system may preferably search for the nearest establishment that substantially corresponds to at least one patron preference. The system then preferably generates and/or exports content pages (see FIG. 8) containing alternative establishment records. It will be understood that though the system generates and/or exports content pages in response to search inquiries via the Internet to client machines, any one of a number of communication means (e.g. email, SMS over a cellular telephone network, MMS, etc.) that would be known to those having ordinary skill in the art with the present disclosure before them are likewise contemplated for use in accordance with the present invention.

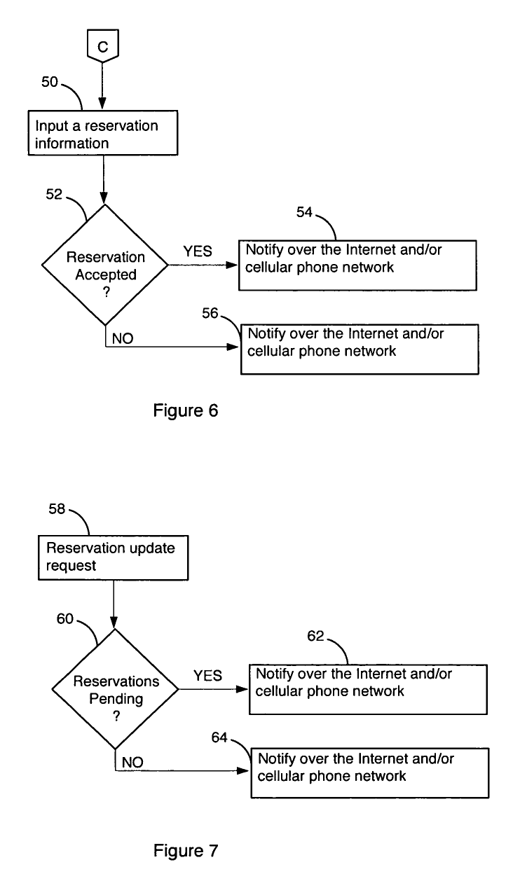

Referring now to FIG. 6, a flowchart of a process controlling reservations is shown. Once a user and/or patron has located a suitable establishment record, step 50 preferably allows that patron to input reservation information. Reservation information may comprise, for example, a party name, a reservation time, a reservation quantity, and a seating preference. Reservation information is received via a content page (see FIG. 8) from step 46 or step 48. Once a reservation request has been inputted, the reservation request is transmitted to the appropriate establishment. Step 52 then determines whether the reservation is accepted or rejected. If the reservation is accepted, execution preferably branches to step 54 and the patron is notified that their reservation has been accepted. This notification may occur via a process within the system, or may occur via direct communication between the establishment and the patron. Examples of types of notification include an electronic mail notification generated by the system or a short message service (text message) generated by the system that is sent to a patron's cellular phone. It will be understood that if the reservation request is denied, execution preferably branches to step 56 and notification likewise occurs.

Reservations are stored within a patron record so that a patron may access the system and verify pending reservation requests and notifications.

Referring now to FIG. 7, a flowchart of a process controlling reservation updates is shown. The system may preferably provide notification to a patron of any pending reservations. This process is known as a reservation update. First, step 58 preferably requires a patron to send a short message system (text message) that notifies the system that a reservation update has been requested. It will be understood that a patron must input their cellular phone number into their patron record for this short message system (text message) automated process.

Once the user has requested a reservation update, execution preferably branches to step 60. Step 60 determines whether there are any pending reservations for that cellular phone number. If there are pending reservations stored in a patron record, execution preferably branches to step 62 and the system sends a short message system (text message) that notifies the patron of any pending reservations. Likewise if there are no pending reservations for that cellular phone number, execution branches to step 64 and the system sends a short message system (text message) that notifies the patron that no pending reservations exist. It will be understood that although a short message system (text message) has been discussed, any one of a number of messaging means (e.g. email, MMS, etc.) that would be known to those having ordinary skill in the art with the present disclosure before them are likewise contemplated for use in accordance with the present invention.

Referring now to FIG. 8, a view of a generated content page containing activity information is shown. In this embodiment, content page 70 is shown as comprising reservation input members 72. Reservation input members 72 are shown as comprising text input boxes that receive user input. In one embodiment, content page 70 comprises three text input boxes, one for receiving a party name, another for receiving a reservation quantity, and yet another for receiving a reservation time. Once a user has input reservation information into the aforementioned text input boxes, the user clicks button 74. Clicking button 74 preferably executes a command that prompts the system to communicate the reservation request to an establishment.

In accordance with the present invention, content page 70 comprises previous activity level button 76. In this embodiment, previous activity level button 76 is shown as comprising a clickable button. Once a user clicks previous activity level button 76, the system retrieves and displays, for example, previous wait lists, previous reservation lists, and previous occupancy numbers for the last 30 days. It will be understood that the system may provide previous data for any time period.

Also, content page 70 may preferably comprise real-time activity information. This activity information may comprise, for example, current occupancy number 78 and current wait list 80. In one embodiment, content page 70 preferably comprises webcam feed 82. Webcam feed 82 comprises information broadcast over the Internet by a webcam located in an establishment.

The foregoing description merely explains and illustrates the invention and the invention is not limited thereto except insofar as the appended claims are so limited, as those skilled in the art who have the disclosure before them will be able to make modifications without departing from the scope of the invention.

What is claimed:

1. An electronic business method for monitoring the activity of an establishment, comprising the steps of:
providing an electronic information database associated with a server, wherein the electronic information database comprises at least one establishment record;
storing activity information about an establishment within an establishment record;
receiving a search inquiry regarding the activity of an establishment; and
generating at least one content page via a server, wherein the at least one content page comprises activity information about an establishment that is stored within an establishment record which substantially corresponds to a search inquiry.

2. The electronic business method according to claim 1, further comprising the step of exporting views of the at least one content page over a computer network.

3. The electronic business method according to claim 1, further comprising the step of authorizing a user by:
requesting a user identification from a user;
determining whether the user identification is authentic; and
granting access to modify an establishment record if the user identification is valid or denying access to modify an establishment record if the user identification is invalid.

4. The electronic business method according to claim 1, further comprising the step of receiving activity information about the activity of an establishment, wherein the step of receiving activity information about the activity of an establishment is performed over an interface protocol.

5. The electronic business method according to claim 4, wherein the interface protocol comprises a world wide web application running hypertext transfer protocol.

6. The electronic business method according to claim 1, wherein the step of authorizing a user is before the steps of storing activity information about an establishment within an establishment record and receiving activity information about the activity of an establishment.

7. The electronic business method according to claim 1, further comprising the step of storing a patron record in an electronic information database.

8. The electronic business method according to claim 7, wherein the patron record further comprises a patron preference, wherein the patron preference comprises at least one of: a favorite establishment list, an activity upper limit, an activity lower limit, a proximity limit, and a price limit.

9. The electronic business method according to claim 7, further comprising the step of storing reservation information within a patron record.

10. The electronic business method according to claim 9, wherein the reservation information comprises at least one of: a party name, a reservation time, a reservation quantity, and a seating preference.

11. The electronic business method according to claim 10, further comprising the step of receiving a request for a reservation update.

12. The electronic business method according to claim 11, further comprising the step of notifying a patron of a reservation update, wherein the reservation update comprises reservation information contained within a patron record.

13. The electronic business method according to claim 8, further comprising the step of providing an alternative establishment record based upon at least one of a search inquiry and a patron preference.

14. The electronic business method according to claim 1, further comprising the step of notifying a user of the activity of an establishment by transmitting activity information via a cellular telephone network.

15. The electronic business method according to claim 1, further comprising the step of notifying a user of the activity of an establishment by transmitting activity information via an Internet protocol to an associated computer.

16. The electronic business method according to claim 1, wherein the activity information comprises an interactive monitoring device.

17. The electronic business method according to claim 1, wherein the activity information comprises at least one of: an establishment's current occupancy number, an establishment's previous occupancy number, a current reservation list, and a current call ahead list.

18. The electronic business method according to claim 1, wherein the establishment record comprises an establishment identification, wherein the establishment identification comprises at least one of: a unique identification data, an address, and an establishment name.
